(19) United States
(12) Patent Application Publication
(10) Pub. No.: US 2023/0046462 A1
(43) Pub. Date: Feb. 16, 2023

(54) ENTITLEMENT FRAMEWORK FOR A BOT OF BOTS NETWORK

(71) Applicant: Bank of America Corporation, Charlotte, NC (US)

(72) Inventors: Priyank R. Shah, Plano, TX (US); Castigliana Cimpian, San Francisco, CA (US)

(21) Appl. No.: 17/398,670

(22) Filed: Aug. 10, 2021

(51) Int. Cl. H04L 12/58

(52) U.S. Cl. CPC H04L 51/02

(57) ABSTRACT

A bot of bots entitlement framework is provided. The framework may include a plurality of bots. The framework may include an entitlement layer. The entitlement layer may determine whether a requestor is entitled to receive a response to a request. The determination may be based on a consumer associated with the request, a topic of the request and a level of the bot responding to the request. The requestor may transmit a request to a first bot. The first bot may determine whether the first bot can provide a response to the requestor based on whether data for the response is included in a database to which the first bot has access. The first bot may transmit the request to the entitlement layer. The entitlement layer may determine that the requestor has access to the requested data. The first bot may respond to the requestor.

### FIELD OF TECHNOLOGY

Aspects of the disclosure relate to chatbots.

### BACKGROUND OF THE DISCLOSURE

Chatbots are used to automate conversations and interact with humans through various communication platforms. Chatbots may be powered by pre-programmed responses, artificial intelligence and/or machine learning in order to answer questions with or without contacting a live human agent. As such, chatbots can be used in lieu of providing direct contact with a live human agent. Chatbots may simulate conversations with a human using text, text-to-speech or speech-to-speech.

Many entities maintain a single chatbot. The single chatbot may include information relating to a specific domain of intents. For example, the entity may relate to selling furniture. As such, the chatbot may be trained to respond to information requests relating to furniture.

However, there are some entities that maintain multiple chatbots. Such entities may include various departments. Each department may maintain its own chatbot. However, although multiple chatbots may exist at a single entity, each chatbot must be accessed separately. In legacy chatbot applications, there is typically no communication between or among chatbots.

It would be desirable for seamless communication between chatbots. It would be further desirable for entitlements of the inter-chatbot communications to be managed by an entitlement framework.

### SUMMARY OF THE DISCLOSURE

Apparatus, methods and systems for an entitlement framework for a bot of bots network is provided. Bots may be applications that are resident on hardware processors and interact with humans. Bots may be powered by pre-programmed responses, artificial intelligence and/or machine learning to simulate conversations with humans. Bots may reduce the time needed for human operators to interact with human callers.

Bots may function while accounting for entitlement and eligibility. In a single bot environment in may be relatively less complex to determine whether the requestor is entitled to a particular request. However, in a bot of bots network, when bots hand off requests to different bots, and different bots maintain different entitlement levels, it may be relatively more complex to maintain correct entitlements.

In an example, a consumer may be able to login to a human resource bot. The consumer login may require whatever necessary credentials, such as a biometric identifier, a user identifier (ID) and/or password, to authenticate the consumer vis-à-vis the human resource bot. The human resource bot may be external to the entity associated with the consumer. The consumer may communicate with the human resource bot about paycheck, tax deductions and other human resource topics. Such communication between the consumer and the human resource bot may be permissioned.

In another example, the consumer may login to an entity bot. The entity bot may be internal to the entity associated with the consumer. The consumer login may not require any credentials to authenticate the consumer vis-à-vis the entity bot. The consumer may communicate with the entity bot about entity topics. The consumer may communicate with the entity bot regarding human resource topics. However, the entity bot may not have access to the data relating to the human resource topics. As such, the entity bot may transfer the communication to the human resource bot. It should be appreciated that, at times the communication may be completely transferred to the human resource bot. Other times, the entity bot may serve as a liaison and enable communication between the consumer and the human resource bot through the entity bot. At the human resource bot, the human resource bot may be required to authenticate the consumer in order to respond to the consumer's request.

Therefore, an entitlement framework is provided. The entitlement framework may provide an entitlement layer, also referred to herein in this application as an entitlement tier. In some embodiments, the entitlement tier may be linked to each bot. In other embodiments, one or more entitlement tiers may be used for a plurality of bots.

The entitlement layer may ensure that the information provided to a consumer is authorized to be provided to the consumer. The entitlement layer may also ensure that the bot providing the information is authorized to provide the information.

The bot of bots entitlement framework may include, and or interact with, a plurality of bots. The plurality of bots may include one or more front-end bots. The front-end bots may be operable to receive requests. The front-end bots may be permissioned to, and operable to, access a first database.

The plurality of bots may include one or more mid-level bots. The mid-level bots may be operable to receive requests. The mid-level bots may be permissioned to, and operable to, access a second database.

The plurality of bots may include one or more high-end bots. The high-end bots may be operable to receive requests. The high-end bots may be permissioned to, and operable to, access a third database.

The first database may be a subset of the second database. The second database may be a subset of the third database. The first, second and third databases may be separate from each other.

At times, the entitlement tier may determine that a first bot, such as a front-end bot or mid-level bot, is not permissioned to access data for a specific request. However, the entitlement tier may determine the requestor is permissioned to receive the data from the request. Therefore, the entitlement tier may indicate to the first bot to transfer the request to a second bot, such as a mid-level bot or high-end bot. The transfer of the request from the first bot to the second bot may include entitlement metadata. As such, a user may not be required to reidentify itself at the second bot. It should be appreciated that, at times, a request may be directed initially to a mid-level bot, and the mid-level bot is not permissioned to access the data relating to the request, the entitlement tier may direct the request to a front-end bot, which may have access to the necessary data. It should be noted that, in some embodiments, front-end bots may be entity-specific bots, while mid-level bots and high-end bot may be vendor bots.

In some embodiments, the entitlement framework may include three entitlement tiers: a bot level tier, a consumer level tier and a topic level tier. The bot level tier may ensure that the bot is permissioned, and/or enabled to access the data. The consumer level tier may ensure that the consumer is permissioned, and/or enabled to receive the data. The topic level tier may ensure that the request from the consumer is included in a topic available to both the bot and the consumer.

In other embodiments, the entitlement tier may determine whether a requestor is entitled to receive a response to the request based on a plurality of factors. The factors may include the consumer associated with the request, the topic of the request, the level of the bot responding to the request (such as front-end, mid-level or high-end) and any other suitable factors.

The requestor, such as the consumer, may transmit the request to a front-end bot. The front-end bot may determine whether the front-end bot can provide the response to the requestor. The determination of whether the front-end bot can provide the response to the requestor may be based on whether the data relating to the response is included in the first database.

When the front-end bot can provide a response to the requestor, the front-end bot may determine whether the requestor is entitled to the response. The determination of entitlement may include transmitting identification of the request, identification of the response, identification of the requestor, a topic of the request and identification of the responsive bot, which is the front-end bot, to the entitlement tier. The entitlement tier may determine whether the front-end bot is entitled to respond to the requestor. The response may be based on the received identification of the request, identification of the response, identification of the requestor, the topic of the request and identification of the responsive bot.

When the front-end bot is entitled to respond to the requestor, the entitlement tier may authorize the front-end bot to respond to the requestor. Upon receipt of authorization at the front-end bot, the front-end bot may respond to the requestor. When the front-end bot is not entitled to respond to the requestor, the entitlement tier prevents the front-end bot from responding to the requestor.

When the front-end bot cannot provide a response to the requestor, the front-end bot may deny the request or direct the request to a mid-level bot. The mid-level bot may transmit the identification of the request, the identification of the response, the identification of the requestor, the topic of the request, the identification of the responsive bot, which is the mid-level bot, to the entitlement tier. The entitlement tier may determine whether the mid-level bot is entitled to respond to the requestor. The determination may be based on the identification of the request, the identification of the response, the identification of the requestor, the topic of the request and the identification of the responsive bot. When the mid-level bot is entitled to respond to the requestor, the entitlement tier authorizes the mid-level bot to respond to the requestor.

Upon receipt of the authorization at the mid-level bot, the mid-level bot may respond to the requestor. When the mid-level bot is not entitled to respond to the requestor, the entitlement tier prevents the mid-level bot from responding to the requestor.

When the mid-level bot cannot provide a response to the requestor, the mid-level bot may deny the request or direct the request to a high-end bot. The high-end bot may transmit the identification of the request, the identification of the response, the identification of the requestor, the topic of the request, the identification of the responsive bot, which is the high-end bot, to the entitlement tier. The entitlement tier may determine whether the high-end bot is entitled to respond to the requestor. The determination may be based on the identification of the request, the identification of the response, the identification of the requestor, the topic of the request and the identification of the responsive bot. When the high-end bot is entitled to respond to the requestor, the entitlement tier authorizes the high-end bot to respond to the requestor.

Upon receipt of the authorization at the high-end bot, the high-end bot may respond to the requestor. When the high-end bot is not entitled to respond to the requestor, the entitlement tier prevents the high-end bot from responding to the requestor.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure; and

FIG. 3 shows an illustrative flow chart in accordance with principles of the disclosure.

### DETAILED DESCRIPTION OF THE DISCLOSURE

Apparatus and methods for creating and maintaining a universe of chatbots that are managed by an entitlement framework are provided. The universe of chatbots may be a network of applications that are resident on hardware processors that automate conversations and interact with humans. The network of applications may be powered by pre-programmed responses, artificial intelligence and/or machine learning to simulate conversations with humans.

Methods may include receiving a first portion of a request at a first bot within the bot of bots network. The first portion of the request may be received together with a set of entitlement metadata relating to the first portion of the request.

Methods may include identifying a maximum allowed value for each of a plurality of entitlement tiers. The identification may be executed at the first bot. The maximum allowed value may be based on a requestor associated with the request, the first bot, the topic of the request, the first portion of the request, the set of entitlement metadata and/or any other suitable data. The maximum allowed value may be received from any suitable entity.

The plurality of entitlement tiers may correspond to a bot tier, a consumer tier and a topic tier. The bot tier may include a plurality of bots, and a set of permissions associated with each bot included in the plurality of bots. The plurality of bots may include a front-end bot, a mid-level bot and a high-level bot. The front-end bot may be permissioned to, and configured to, access a first database. As such, the front-end bot may be apprised of a structural request format for accessing data from the first database. The mid-level bot may be permissioned to, and configured to, access a second database. As such the mid-level bot may be apprised of a structural request format for accessing data from the second database. The high-level bot may be permissioned to, and configured to, access a third database. As such, the high-level bot may be apprised of a structural request format for accessing data from the third database.

The consumer tier may include a plurality of predetermined qualifications associated with a consumer that transmitted the request. The plurality of predetermined qualifications may include an indication of whether the consumer has fully authenticated or partially authenticated. The indication may also indicate a level of authentication associated with the authenticated consumer. Examples of levels of authentication may include a username/password authentication, a biometric authentication and a two-factor authentication including both a username/password and a biometric authentication. The plurality of predetermined qualifications may include an indication of whether the consumer is a primary consumer, a secondary consumer or tertiary consumer.

One example a consumer may be a customer to an entity. The customer may be a level one customer or a level two customer. Level one customers may have access to different data and different bots than level two customers. In one example, a level one customer may be an owner of a small business while a level two customer may be an employee, such as a bookkeeper of the small business. In another example, a level one customer may be a preferred customer, while a level two customer may be a standard customer.

Another example of a consumer may be an agent. The agent may be a representative of an entity, such as an employee. Each agent, or group of agents, may have access to different databases, or different bots, based on the lines of business with which the agent is associated. For example, a first agent that is associated with mortgages may have access to mortgage data and a mortgage bot, while a second agent that is associated with payment cards may have access to payment card data and a payment card bot. The first agent may not have access to payment card data or the payment card bot, while the second agent may not have access to mortgage data and the mortgage bot. In another example, a first agent that is associated with technical support may not have access to the data to which a human resources agent has access.

The topic tier may include a plurality of topics and a set of permissions associated with each topic included in the plurality of topics. The plurality of topics may include a human resources topic, an entity-wide topic and/or a specific line-of-business topic.

Methods may include identifying a current value for each of the plurality of entitlement tiers. The identification may be executed at the first bot. The current value may be based on a requestor associated with the request, the first bot, the topic of the request, the first portion of the request, the set of entitlement metadata and/or any other suitable data.

Methods may include identifying whether the current value is greater than the maximum allowed value for each tier included in the plurality of entitlement tiers. As such, the comparison between the current values and the maximum allowed values may determine whether the current request, and its components, such as requestor, bot and topic, is allowed within the entitlement framework.

In some embodiments, the identifying may utilize a multidimensional lookup table. The multidimensional lookup table may include a plurality of dimensions. Each dimension may correspond to an entitlement tier. The plurality of dimensions may include a bot dimension, a consumer dimension and a topic dimension.

In some embodiments, the identifying may utilize a graphic implementation. The graphic implementation may include a plurality of nodes. Each node may depend on, or provide a dependency to, at least one other node. Each node may represent a data structure that corresponds to an entitlement tier. Each node may illuminate based on its current value vis-à-vis the maximum allowed value for the entitlement tier that the node represents. The illumination may be in either a red color or in a green color. A red color may indicate preventing access to the data structure while a green color may indicate allowing access to the data structure. Other suitable colors or illuminations may also be utilized. In some embodiments, nodes may only illuminate when access is allowed. In certain embodiments, nodes may only illuminate when access is denied.

In certain embodiments, the identifying may utilize machine learning and/or artificial intelligence. As such, historical requests, and entitlements of the historical requests, may be provided to the entitlement tier in order to train the entitlement tier regarding entitlement data.

When the current value is greater than the maximum allowed value, for at least one tier included in the plurality of entitlement tiers, the first portion of the request may be denied.

Methods may also include prompting a suggestion to the requestor. The suggestion may alter the first portion of the request to reduce the current value for each entitlement tier value that is greater than the maximum allowed value. As such, the suggested request may be entitled to the requestor.

When the current value is equal to or less than the maximum allowed value for each of the plurality of entitlement tier values, the request may be entitled to the requestor. As such, methods may include identifying a response to the first portion of the request at the first bot. Methods may include presenting the response to the first portion of the request to the requestor. The presenting may be executed at a graphical user interface (GUI).

Methods may include receiving a second portion of the request at the first bot. Methods may include re-identifying the current value for each of the plurality of entitlement tier values. The re-identifying may be executed at the first bot. The current value may be based on the second portion of the request and/or the set of entitlement metadata.

In some embodiments, methods may include identifying that the current value for each entitlement tier value is equal to or less than the corresponding maximum allowed value. Methods may include identifying a response to the second portion of the request at the first bot. Methods may include presenting the response to the second portion of the request to the requestor. The presenting may be executed at a GUI.

In certain embodiments, methods may include identifying that the current value for each entitlement tier value is greater than the corresponding maximum allowed value. As such, methods may deny the second portion of the response at the first bot or methods may request additional authentication information from the requestor.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

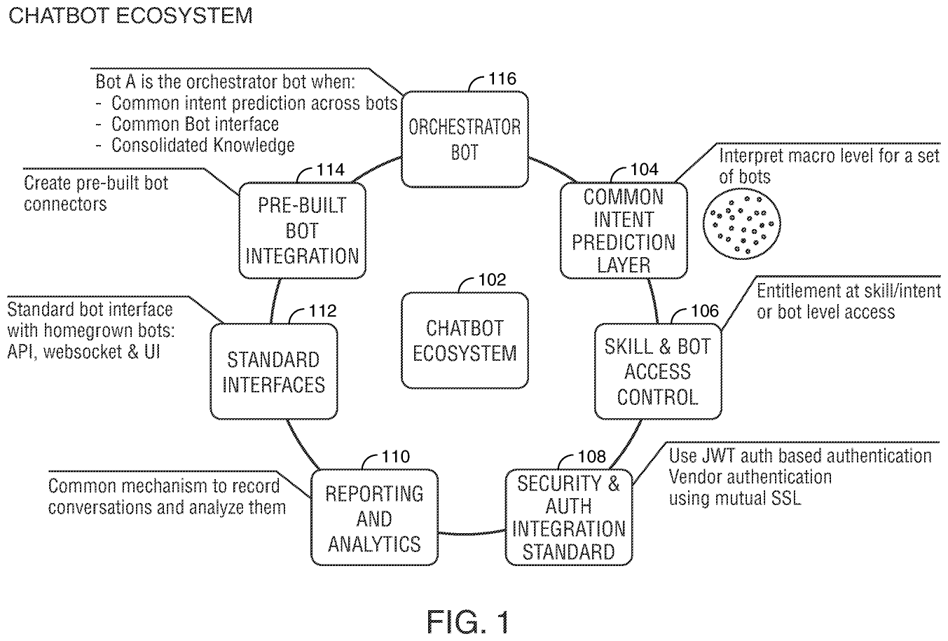

FIG. 1 shows a chatbot ecosystem. A chatbot ecosystem may be an ecosystem that includes various components of chatbots and how the chatbots operate together within a single ecosystem. The chatbot ecosystem may also collaborate and/or work together with chatbots that are external to the chatbot ecosystem. Such external chatbots may include vendor or third-party chatbots.

Container 102 shows a chatbot ecosystem. Various components of the chatbot ecosystem are shown surrounding container 102.

The components of the chatbot ecosystem may include an orchestrator bot, shown at 116. An orchestrator bot may be a bot that directs an incoming query to a domain-based bot. The domain of the domain-based bot may correspond to the domain of the incoming query.

In a training environment, the orchestrator bot may receive labeled training data. As such, the orchestrator bot may receive a query that has already been labeled with a domain.

In a production environment, the query may be received at the orchestrator bot with or without a labeled domain. In the event that the query is received labeled with a domain, the system may utilize machine learning and/or artificial intelligence to determine whether the domain with which the query was labeled is the correct domain. In the event that the query is received without a domain, machine learning and/or artificial intelligence at the orchestrator bot may determine a domain appropriate for the query.

In some embodiments, the orchestrator bot may be associated with a first domain and have limited knowledge of other domain bots. In such embodiments, the orchestrator bot may also be a domain bot, yet the orchestrator bot may have knowledge of other bots. In the event that a query is received at such an orchestrator bot, the orchestrator bot may answer the query when the query is associated with the same domain as the bot. In the event that a query is received at such an orchestrator bot, the orchestrator bot may also answer the query if the answer to the query is included within the limited knowledge of other bots included in the orchestrator bot. In the event that a query is received at such an orchestrator bot, the orchestrator bot may also retrieve knowledge from a bot associated with a different domain. In the event that a query is received at such an orchestrator bot, the orchestrator bot may channel the query to a different bot associated with a domain that is associated with the query.

A bot may be an orchestrator bot when the bot includes common intent prediction across bots. As such, a bot may be an orchestrator bot when each bot included in the ecosystem includes a common intent prediction layer. Common intent prediction layer may be the layer included in each bot that enables each bot to generate a prediction for a query. An orchestrator bot may be able to direct a query to the appropriate domain specific bot for intent prediction.

A bot may also be an orchestrator bot when the bot includes and/or has knowledge regarding a common bot interface. The common bot interface may enable a bot to interface with one or more other bots.

A bot may also be an orchestrator bot when the bot includes consolidated knowledge. Consolidated knowledge may include various small amounts of knowledge regarding other bots. As such, Bot A, which may know a universe of data regarding domain A, may include small amounts of knowledge regarding domain B, domain C and domain D.

The components of the chatbot ecosystem may include a common intent prediction layer, shown at 104. The common intent prediction layer may be a logic layer that interprets and determines the intent of a prediction. The common intent prediction layer may interpret macro level predictions for a set of bots. The common intent prediction layer may utilize one or more processes for predicting intents. Examples of such processes are included in co-pending, commonly owned patent application Ser. Nos. 17/243,728, 17/243,738 and 17/243,750, all of which are hereby incorporated by reference herein in their entirety.

The components of the chatbot ecosystem may include a skill and bot access control layer, shown at 106. The skill and bot access control layer may identify access for bot entitlements based on skill, intent or bot level.

The components of the chatbot ecosystem may also include a security and auth-integration standard, shown at 108. The security and auth-integration standard may include a layer of security and authorization required and executed prior to a user and/or bot accessing specific data. The security and auth-integration may be bot specific and/or user specific. As such, the security and auth-integration layer may allow users and/or bots to access appropriate data. However, the security and auth-integration layer may prevent users and/or bots from accessing data to which the users and/or bots are restricted from accessing.

For example, a user may have access to all of the data included in Bot A and have access to only a portion of the data included in Bot B. As such, the security and auth-integration layer may allow the user to access all of the data in Bot A, allow the user to access the portion of the data in included in Bot B to which the user has permission to access and prevent the user from accessing the portion of data included in Bot B to which the user is restricted from accessing. In another example, Bot A may have access to the data included in Bot B and have access to only a portion of the data included in Bot C. As such, the security and auth-integration layer may allow Bot A to access the data included in Bot B, allow Bot A to access the portion of data included in Bot C to which Bot A has permission to access and prevent Bot A from accessing the portion of data included in Bot C that Bot A is restricted from accessing.

At times, the permissions of bots and/or users may contradict. In some embodiments, the security and auth-integration layer may implement the most restrictive permissions. For example, Bot A may be allowed to access Bot B, however, an exemplary user X accessing Bot A may be restricted from accessing Bot B. As such, when user X is accessing Bot A, Bot A may be restricted from accessing Bot B. In other embodiments, the security and auth-integration layer may implement the least restrictive permissions. For example, Bot A may be allowed to access Bot B, however, user X accessing Bot A may be restricted from accessing Bot B. As such, when user X is accessing Bot A, user X may be allowed to access Bot B.

The security and auth-integration standard may utilize JavaScript Object Notation (JSON) Web Token (JWT) to implement these security standards. The security standards may be an enterprise application programming interface (API) management solution-enabled authentication. The enterprise API management solution may include a centralized API catalog, centralized API management, centralized API standards and centralized API policies. The security standards may utilize a mutual secure sockets layer (SSL). An SSL may be a computing protocol that utilizes encryption to secure data transmitted over a network, such as the Internet.

The components of the chatbot ecosystem may also include a reporting and analytics layer, shown at 110. The reporting and analytics layer may include one or more mechanisms for recording conversations and analyzing the recorded conversations.

The components of the chatbot ecosystem may also include a standard interfaces layer, shown at 112. The standard interfaces layer may create a standard or universal language for bot-to-bot communications. As such, the application programming interfaces (APIs), WebSockets and user interfaces may follow a predetermined protocol. Therefore, the communications between bots are seamless and preferably remove a translation layer between bots. It should be appreciated that standard interfaces layer 112 may also include a translation layer/barrier. Details of the translation layer/barrier are included in co-pending, commonly-owned patent application Ser. No. 17/363,574, which is hereby incorporated by reference herein in its entirety. The translation layer/barrier may translate requests originating from bots external to an internal bot network. The translation layer/barrier may also translate responses originating from bots internal to the internal bot network and being transmitted to bots external to the internal bot network.

The components of the chatbot ecosystem may also include pre-built bot integration, shown at 114. Pre-built bot connectors may be connectors that connect bots. The pre-built bot connectors may be instrumental in implementing a standard interfaces layer. Pre-built bot connectors may provide a conversion layer between the bots within a bot network.

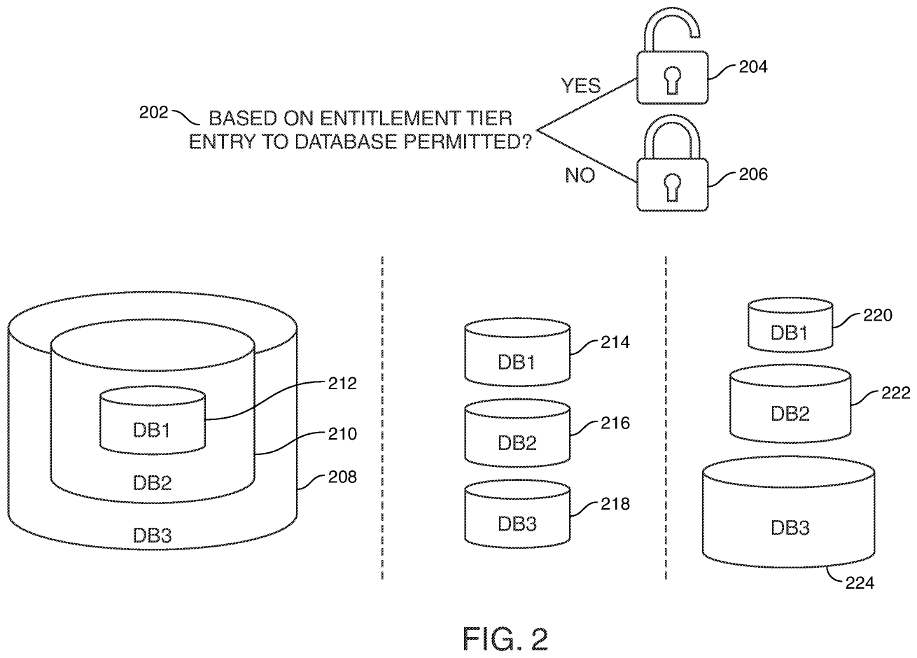

FIG. 2 shows an illustrative diagram. When a request is received at a bot, the bot may locate the response to the request within a database. Certain databases may be open to all bots. Certain databases may be available to a first group of bots. Other databases may be available to a different group of bots. Access, or entry, to a database may be determined based on the entitlement tier. The entitlement tier may determine access based on a variety of factors, such as bot, requestor, topic of request and any other suitable factors.

The illustrative diagram illustrates whether access to a database is permitted or denied for a request. The access may be permitted or denied based on the entitlement tier, as shown at 202. When an entitlement tier indicates that entry to a database is permitted, access may be granted as shown at 204. When an entitlement tier indicates that entry to a database is prevented, access may be denied as shown at 206.

It should be noted that the databases, to which access may be permitted or denied may be shown in a plurality of configurations. A first configuration may indicate that database one may be a subset of database two, and database two may be a subset of database three. Database 1, of the first configuration, may be shown at 212. Database 2, of the first configuration, may be shown at 210. Database 3, of the first configuration, may be shown at 208.

A second configuration may indicate that databases 1, 2 and 3 may be similar-sized. The second configuration may also indicate that databases 1, 2 and 3 may be three distinct databases. Database 1, of the second configuration, may be shown at 214. Database 2, of the second configuration, may be shown at 216. Database 3, of the second configuration, may be shown at 218.

A third configuration may indicate that databases 1, 2 and 3 may be different sized. The third configuration may also indicate that databases 1, 2 and 3 may be three distinct databases. Database 1, of the third configuration, may be shown at 220. Database 2, of the third configuration, may be shown at 222. Database 3, of the third configuration may be shown at 224. Database 2, of the third configuration may be larger than database one, of the third configuration. Database 3, of the third configuration, may be larger than database 2 of the third configuration.

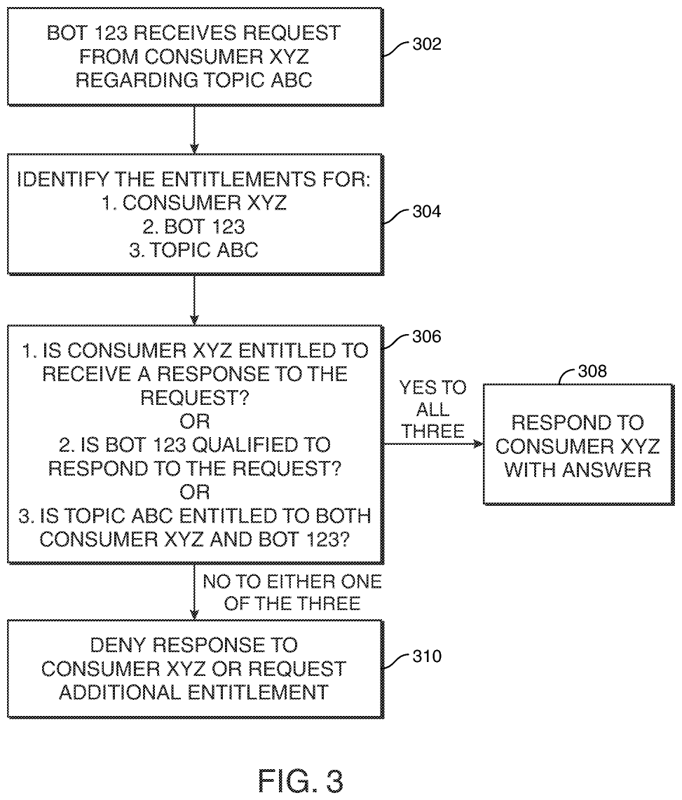

FIG. 3 shows an illustrative flow chart. Step 302 shows Bot 123 receives a request from consumer XYZ regarding topic ABC. Step 304 shows identification of the entitlements for consumer XYZ, Bot 123 and topic ABC.

Step 306 shows a query. The query may be the following: Is consumer XYZ entitled to receive a response to the request or Is Bot 123 qualified to respond to the request or Is topic ABC entitled to both consumer XYZ and Bot 123.

If the response is yes to all three portions of the query shown at step 306, an answer is responded to consumer XYZ, as shown at 308.

If the response is no to either one of the three portions of the query shown at step 306, the response to consumer XYZ is denied or additional entitlement is requested, as shown at 310.

Thus, an entitlement framework for a bot of bots network is provided. Persons skilled in the art will appreciate that the present invention can be practiced by other than the described embodiments, which are presented for purposes of illustration rather than of limitation. The present invention is limited only by the claims that follow.

1. A bot of bots entitlement framework comprising:
a plurality of bots, said plurality of bots comprising:
one or more front-end bots:
operable to receive a request; and
permissioned to, and operable to, access a first database;
one or more mid-level bots:
operable to receive the request; and
permissioned to, and operable to, access a second database; and
one or more high-end bots:
operable to receive the request; and
permissioned to, and operable to, access a third database;
an entitlement tier, wherein the entitlement tier determines whether a requestor is entitled to receive a response to the request based on:
a consumer associated with the request;
a topic of the request; and
a level of a bot responding to the request, said level being either a front-end, a mid-level or a high-end;
wherein:
the requestor transmits the request to a front-end bot included in the one or more front-end bots;
the front-end bots determines whether the front-end bot can provide the response to the requestor based on whether data for the response is included in the first database;
when the front-end bot can provide a response to the requestor, the front-end bot transmits identification of the request, identification of the response, identification of the requestor, a topic of the request, and identification of the responsive bot, which is the front-end bot, to the entitlement tier;
the entitlement tier determines, based on the identification of the request, the identification of the response, the identification of the requestor, the topic of the request and the identification of the responsive bot, whether the front-end bot is entitled to respond to the requestor;
when the front-end bot is entitled to respond to the requestor, the entitlement tier authorizes the front-end bot to respond to the requestor; and
upon receipt of authorization at the front-end bot, the front-end bot responds to the requestor.

2. The framework of claim 1, wherein, when the front-end bot is not entitled to respond to the requestor, the entitlement tier prevents the front-end bot from responding to the requestor.

3. The framework of claim 1, wherein when the front-end bot cannot provide a response to the requestor:
the front-end bot directs the request to a mid-level bot included in the one or more mid-level bots;
the mid-level bot transmits the identification of the request, the identification of the response, the identification of the requestor, the topic of the request, and the identification of the responsive bot, which is the mid-level bot, to the entitlement tier;
the entitlement tier determines, based on the identification of the request, the identification of the response, the identification of the requestor, the topic of the request and the identification of the responsive bot, whether the mid-level bot is entitled to respond to the requestor;
when the mid-level bot is entitled to respond to the requestor, the entitlement tier authorizes the mid-level bot to respond to the requestor; and
upon receipt of authorization at the mid-level bot, the mid-level bot responds to the requestor.

4. The framework of claim 3, wherein when the mid-level bot is not entitled to respond to the requestor, the entitlement tier prevents the mid-level bot from responding to the requestor.

5. The framework of claim 3, wherein when the mid-level bot cannot provide a response to the requestor:
the front-end bot directs the request to a high-end bot included in the one or more high-end bots;
the high-end bot transmits the identification of the request, the identification of the response, the identification of the requestor, the topic of the request, and the identification of the responsive bot, which is the high-end bot, to the entitlement tier;
the entitlement tier determines, based on the identification of the request, the identification of the response, the identification of the requestor, the topic of the request and the identification of the responsive bot, whether the high-end bot is entitled to respond to the requestor;
when the high-end bot is entitled to respond to the requestor, the entitlement tier authorizes the high-end bot to respond to the requestor; and
upon receipt of authorization at the high-end bot, the high-end bot responds to the requestor.

6. The framework of claim 5, wherein when the high-end bot is not entitled to respond to the requestor, the entitlement tier prevents the high-end bot from responding to the requestor.

7. The framework of claim 1, wherein the first database is a subset of the second database, and the second database is a subset of the third database.

8. A method for responding to requests, said responding using an entitlement framework within a bot of bots network, said bot of bots network being a network of applications that are resident on hardware processors that automate conversations and interact with humans, said network of applications being powered by pre-programmed responses, artificial intelligence and/or machine learning to simulate conversations with humans, the method comprising:
receiving a first portion of a request and a set of entitlement metadata relating to the first portion of the request, at a first bot within the bot of bots network;
identifying, at the first bot, a maximum allowed value for each of a plurality of entitlement tiers, the plurality of entitlement tiers corresponds to:
a bot tier, the bot tier including a plurality of bots and a set of permissions associated with each bot included in the plurality of bots;
a consumer tier, the consumer tier including a plurality of predetermined qualifications associated with a consumer that transmitted the request; and
a topic tier, the topic tier including a plurality of topics and a set of permissions associated with each topic included in the plurality of topics;
identifying, at the first bot, a current value for each of the plurality of entitlement tiers, said current value being based on:
the first portion of the request; and
the set of entitlement metadata relating to the first portion of the request;
identifying whether the current value is greater than the maximum allowed value for at least one tier included in the plurality of entitlement tiers; and
when the current value is greater than the maximum allowed value for at least one tier included in the plurality of entitlement tiers, denying the first portion of the request at the first bot.

9. (canceled)

10. The method of claim 9, wherein:
the plurality of bots includes:
a front-end bot that is permissioned to access and is configured to access a first database;
a mid-level bot that is permissioned to access and is configured to access the first database and a second database; and
a high-level bot that is permissioned to access and is configured to access the first database, the second database and a third database;
the plurality of predetermined qualifications associated with the consumer includes:
an indication whether the consumer has fully authenticated or partially authenticated; and
an indication whether the consumer is a primary consumer, a secondary consumer or a tertiary consumer;
the plurality of topics includes:
a human resources topic;
an entity-wide topic; and
a line-of-business specific topic.

11. The method of claim 8, wherein the identifying that the current value is greater than the maximum allowed value for at least one entitlement tier included in the plurality of entitlement tiers utilizes a multidimensional lookup table, said multidimensional lookup table comprising a plurality of dimensions, where each dimension included in the plurality of dimensions corresponds to an entitlement tier, the plurality of dimensions comprise a bot dimension, a consumer dimension and a topic dimension.

12. The method of claim 8, wherein the identifying that the current value is greater than the maximum allowed value for at least one tier included in the plurality of entitlement tiers utilizes a graphic implementation.

13. The method of claim 12, wherein:
the graphic implementation comprises a plurality of nodes;
each node included in the plurality of nodes depends on, or provides a dependency to, at least one node included in the plurality of nodes; and
each node included in the plurality of nodes represents a structure of data that corresponds to an entitlement tier included in the plurality of entitlement tiers.

14. The method of claim 13, wherein, for each entitlement tier, the node that corresponds to the entitlement tier illuminates, based on the current value vis-à-vis the maximum allowed value for each entitlement tier, in either a red color or in a green color, where a red color indicates preventing access to the structure of data and a green color indicates allowing access to the structure of data.

15. The method of claim 8, wherein the identifying that the current value for at least one tier included in the plurality of entitlement tiers is greater than the corresponding maximum allowed value utilizes machine learning.

16. The method of claim 8, further comprising prompting a suggestion, said suggestion altering the first portion of the request to reduce the current value for each entitlement tier value that is greater than the maximum allowed value.

17. A method for responding to requests, said responding using an entitlement framework within a bot of bots network, said bot of bots network being a network of applications that are resident on hardware processors that automate conversations and interact with humans, said network of applications being powered by pre-programmed responses, artificial intelligence and/or machine learning to simulate conversations with humans, the method comprising:
receiving a first portion of a request and a set of entitlement metadata relating to the request, at a first bot within the bot of bots network;
identifying, at the first bot, a maximum allowed value for each of a plurality of entitlement tier values, the plurality of entitlement tier values corresponds to:
a bot tier, the bot tier including a plurality of bots and a set of permissions associated with each bot included in the plurality of bots;
a consumer tier, the consumer tier including a plurality of predetermined qualifications associated with a consumer that transmitted the request; and
a topic tier, the topic tier including a plurality of topics and a set of permissions associated with each topic included in the plurality of topics;
identifying, at the first bot, a current value for each of the plurality of entitlement tier values, said current value being based on:
the first portion of the request; and
the set of entitlement metadata relating to the first portion of the request;
identifying whether the current value for each tier value included in the plurality of entitlement tier values is equal to or less than the corresponding maximum allowed value; and
when the current value is equal to or less than the maximum allowed value for each of the plurality of entitlement tier values, identifying a response to the first portion of the request at the first bot; and
presenting the response to the first portion of the request to a requestor.

18. The method of claim 17, further comprising:
receiving a second portion of the request at the first bot;
re-identifying, at the first bot, the current value for each of the plurality of entitlement tier values, said current value being based on:
the second portion of the request; and
the set of entitlement metadata;
identifying that the current value for each entitlement tier value included in the plurality of entitlement tier values is less than or equal to the corresponding maximum allowed value;
identifying a response to the second portion of the request at the first bot; and
presenting the response to the second portion of the request to the requestor.

19. The method of claim 17, further comprising:
receiving a second portion of the request at the first bot;
re-identifying, at the first bot, the current value for each of the plurality of entitlement tier values, said current value being based on:
the second portion of the request; and
the set of entitlement metadata;
identifying that the current value for each entitlement tier value included in the plurality of entitlement tier values is greater than the corresponding maximum allowed value;
requesting authentication information from the requestor.

20. The method of claim 17, further comprising:
receiving a second portion of the request at the first bot;
re-identifying, at the first bot, the current value for each of the plurality of entitlement tier values, said current value being based on:
the second portion of the request; and
the set of entitlement metadata;
identifying that the current value for each entitlement tier value included in the plurality of entitlement tier values is greater than the corresponding maximum allowed value;
denying the second portion of the response at the first bot.
